(19) United States
(12) Patent Application Publication
(10) Pub. No.: US 2024/0206020 A1
(43) Pub. Date: Jun. 20, 2024

(54) HOLDING DEVICE, HEATER AND METHOD

(71) Applicant: STEGO Holding GmbH, Schwäbisch Hall (DE)

(72) Inventors: Elmar Mangold, Zöbingen, Unterschneidheim (DE); Susanne Luz, Waiblingen (DE); Waldemar Petrov, Kupferzell (DE)

(21) Appl. No.: 18/557,652

(22) PCT Filed: May 4, 2022
(86) PCT No.: PCT/EP2022/062030

§ 371 Date: Oct. 27, 2023

(30) Foreign Application Priority Data
May 5, 2021 (DE) 10 2021 111 665.1

(51) Int. Cl. H05B 3/06; F24H 3/00

(52) U.S. Cl. CPC H05B 3/06; F24H 3/002; F24H 2250/04

(57) ABSTRACT

A holding device for at least one heating element, in particular for a PTC heating element or a mica heating element, including at least two oppositely arranged holding elements, which are spaced apart from one another by a gap, which extends along a longitudinal direction of the holding device and is adapted for receiving at least one heating element, and including a heat transfer body with at least two chambers, which respectively form an inner region, through which a gaseous medium can flow, wherein the opposite holding elements are arranged between the two chambers and the gap connects the inner regions of the chambers.

### CROSS REFERENCE TO RELATED PATENT APPLICATIONS

This is a U.S. national phase patent application of PCT/EP2022/062030 filed May 4, 2022 which claims the benefit of and priority to German Patent Application No. 10-2021-111 665.1, filed on May 5, 2021, the entire contents of each of which are incorporated herein by reference.

### FIELD

The invention relates to a holding device for a heating element, a heater comprising a holding device, and a method.

### BACKGROUND

In control cabinets, temperature changes, especially the change between daytime and nighttime temperatures, cause the formation of condensation, which together with dust and aggressive gases can lead to corrosion. This, together with permanently extreme climatic conditions, increases the risk of operational failures due to leakage currents or flashovers. It is therefore necessary to ensure consistently optimal climatic conditions for the proper functioning of the components located in the control cabinet. For this purpose, heaters or fan heaters are used, whose reliability and durability are subject to high demands.

Such heaters are equipped, for example, with a mica heater or with electrical heating elements based on PTC semiconductor technology. Alternatively, other heating elements are possible. The holding devices of such heating elements must ensure good heat transfer and secure fixation on the one hand, and allow easy installation on the other. Frequent temperature changes can lead to material fatigue and thus to a reduction in the contact between the heating element and the heat sink and thus to a reduced heat flow. If the contact surface fails, it can lead to overheating of the heating element and thus to a failure of the heating function.

An example of such a heater with a PTC heating element is described in DE 10 2006 018 151 A1. Here, the heating element is arranged in a centrally located recess of a heat exchanger. The heating element lies flat against the inner surfaces of the recess. The heating element is thus held in position in that the ends of the side walls of the heat exchanger are bent inward during assembly by the use of pressing tools. As a result, the inner surfaces lie so closely against the heating element that the heating element is clamped flat and heat transfer is ensured.

Plastic deformation and the effect of temperature result in dislocations in the microstructure. The buckling of the side walls represents a plastic deformation of the material, which in combination with frequent temperature changes impairs the holding function. It is not possible to replace the heating element due to the way it is mounted, which causes the side walls to be permanently plastically deformed.

A holding body for a heating element is known from DE 10 2011 054 752 A1. The known holding body has a shaft with two opposite shaft walls in which a heating element is arranged. The shaft walls are separated by side slots. The holding body further comprises two clamping sections, each of which is arranged laterally on the holding body. The clamping sections are curved and extend substantially in a direction perpendicular to the shaft walls. By compressing the clamping sections in the direction of the side slots, the distance between the shaft walls for arranging a heating element can be increased and decreased again. The force required to open the shaft is applied from the outside.

In the known holding body, the shaft can thus be enlarged in a simple manner in order to arrange a heating element therein. To further improve ease of assembly, it is desirable to change the width of the mounting gap, in particular to increase it.

### SUMMARY

The invention is therefore based on the object of specifying a holding device which enables the heating element to be held securely in the holding device and simplifies assembly. Furthermore, the invention is based on the object of providing a heater with such a holding device as well as a method for manufacturing such a holding device.

According to the invention, the task is solved with a view to
the holding device by the subject matter of claim 1,
the heater by the subject matter of claim 19,
the method by the subject matter of claim 20.

Specifically, the object is solved by a holding device for at least one heating element, in particular for a PTC heating element or a mica heating element, comprising at least two oppositely arranged holding elements which are spaced apart from one another by a gap, which extends along a longitudinal direction of the holding device and is adapted to receive at least one heating element, and comprising a heat transfer body having at least two chambers, which each form an inner region through which a gaseous medium can flow, wherein the opposite holding elements are arranged between the two chambers and the gap connects the inner regions of the chambers. According to the invention, at least one tension profile is arranged on at least one outer surface of the holding elements, to which profile a tensile force can be applied in order to increase the size of the gap for receiving the at least one heating element, wherein the chambers have chamber walls, which form lever arms at least in sections, wherein the lever arms can be elastically deformed at least in sections by the tensile force and are connected to the holding elements in such a way that, in the installed state, a holding force is applied to the at least one heating element.

Where reference is made below to a heating element, multiple heating elements are also included (at least one heating element).

The invention has the advantage that the chamber walls form lever arms which apply a strong and constant holding force to the heating element by the leverage effect. The magnitude of the holding force is adjusted by the person skilled in the art by suitable selection of the gap dimensions and geometries of the lever arms. The tension profile facilitates the assembly of the heating element because the lever arms can be elastically deformed by a tensile force acting on the tension profile, so that the gap between the holding elements can be widened. The heating element or a plurality of heating elements can be easily inserted into the gap in this way. When the tensile force is removed and the elastically deformed lever arms are relieved, they move back to their resting state. In other words, the holding elements are in a mechanically relaxed state when at rest. Due to an oversize of the heating element compared to the gap width in the force-free rest state, an elastic deformation of the lever arms remains so that the heating element in the gap is subjected to the desired holding force.

In the assembled state, the heating element is arranged in the gap and clamped between the holding elements. In the unmounted state, the gap is free. It is clarified that the invention claims both the holding device in the unmounted state, i.e. without the mounted heating element, and in the mounted state, i.e. with the heating element. In the assembled state, the combination of heating element with the holding device according to the invention is also referred to and claimed as a heating device.

Various embodiments of the lever arms are possible, suitable for applying a holding force to the heating element. The various exemplary embodiments are described in more detail below.

The chambers are mechanically coupled to each other. The lever arms of the two chambers formed by the chamber walls are each connected to the holding elements. Since the holding elements are arranged between the chambers, the lever arms engage on both sides of the holding elements. The movement of the holding elements required for assembly is made possible by the fact that the gap connects the inner regions of the chambers. In other words, the gap extends from one chamber to the other chamber and is located in the connecting region of the two chambers. This allows the holding elements to move relative to each other in the transverse direction so that the gap width is variable. In addition, the arrangement of the gap between the chambers has the advantage that in operation there is good heat transfer from the heating element or elements to the inner regions of the chambers and the medium flowing there. Since the heat transfer body dissipates heat to the environment, it can also be referred to as a heat sink.

In a preferred embodiment of the invention, the holding device has a constriction in the region of the connection between the two chambers. The constriction has, relative to the cross-section of the holding device, a smaller extension than the largest extension of at least one chamber, in particular both chambers, in the same direction. In other words, the chambers are wider than the region of the holding device where the chambers are connected to each other. In this exemplary embodiment, the gap is arranged in the region of the constriction.

The chambers of the heat transfer body have several chamber walls. For example, it is possible that the chambers each have at least two chamber walls that delimit the respective inner region. The two chamber walls are arranged opposite each other. More than two chamber walls per chamber are possible, wherein at least a part, in particular all chamber walls act as a lever arm. The shape of the inner region corresponds to the inner contour of the chamber walls.

Preferably, the holding elements are not directly connected or in contact with each other. Rather, the holding elements are connected to the chamber walls, which in turn are connected to each other to form the chambers. Thus, the holding elements are mechanically connected to each other via the chambers, or the chamber walls, forming a gap that extends between the holding elements from one chamber to the other chamber. Since the chamber walls are designed as lever arms and are elastically deformable, the holding elements can be subjected to a leverage force due to the arrangement between the chambers.

Specifically, the holding elements can be moved in a direction perpendicular to the longitudinal direction of the holding device by the tensile force acting on the tension profile.

In other words, the holding elements can be moved elastically towards and away from each other by an external force. If no external force acts on the holding elements and no heating element is arranged between the holding elements, the holding elements are in a rest position. The gap is adapted to accommodate one or more heating elements. This means that one or more heating elements are arranged in the gap in the mounted or assembled state. The width of the gap is greater with a heating element than without a heating element. In other words, the width of the heating element is greater than the width of the gap when the holding elements are in a rest position.

The chamber walls form lever arms which apply a force to the two holding elements in the direction of the opposite holding element when mounted or in operation. For this purpose, the chamber walls are preferably each connected directly or indirectly to a holding element. More specifically, in the assembled state, the chamber walls have a mechanical tension that results in the force applied to the holding elements and holding the heating element. In other words, in the assembled state, when a heating element is located in the gap, the chamber walls are elastically deformed. The force with which the heating element is held in the mounted state can also be referred to as a holding force or a restoring force. The amount of the force depends, among other things, on the length of the chamber walls or the lever arms. Other factors that influence the holding force or clamping force are the material of the holding device, the modulus of elasticity and the geometry of the chamber walls, for example stiffening ribs or material accumulations.

The tension profile serves as an assembly aid and improves the cooling function of the holding device, as it increases the surface area of the heat transfer body. To arrange the heating element in the gap, in particular to push it in, it is necessary for the width of the gap to be increased. For this purpose, the chamber walls of the heat transfer body are elastically deformed. The tension profile serves as a point of application for a tool or an aid through which the necessary tensile force to enlarge the gap can be applied.

The holding device according to the invention is advantageous because it is possible to mount a heating element without plastic deformation of the holding device. This means that a heating element can be removed or replaced if necessary. In addition, the heating element continues to be under tension when heated, which enables better heat output due to the continuous mechanical contact and the resulting low thermal resistance.

This makes it easier to arrange the heating element between the holding elements. Furthermore, a greater holding force can be realized in this way. In particular, the lever arms of the heat transfer bodies enable a high holding force and extended cooling surface. As a result, the heating element has close contact with the holding device and ensures good heat transfer. The chamber walls further enable an advantageously distributed stress pattern. The advantageously distributed stress pattern can avoid localized mechanical stress peaks that could otherwise lead to material failure, in particular cracks or fractures, or a decrease in holding force. The shape is designed to avoid plastic deformation, even locally limited. The function of the holding device is to provide a constant holding force during operation over a longer period of time and thus a good heat transfer or cooling. This function is supported by the lever arms and preferably by the advantageously distributed stress distribution of the lever arms.

Further embodiments of the invention are given in the subclaims.

In a preferred embodiment, the chamber walls of the two chambers each have substantially the same shape, in particular the chamber walls form lever arms of equal length, and the holding elements are arranged centrally between the chambers in a transverse direction. If the chamber walls have the same shape, a heating element in the installed state is subjected to an even holding force from both sides by the lever arms. This enables evenly distributed heat transfer.

In another preferred embodiment, the chamber walls of the two chambers have different shapes from one another, in particular the chamber walls form lever arms of different lengths from one another, so that the holding elements are arranged offset in a transverse direction from the center between the chambers. In this way, the holding force applied to the heating element in the installed state can be varied. Furthermore, various designs of the heat transfer body are possible in this way. For example, one of the two chambers can have a smaller volume than the other of the two chambers.

Embodiments are possible in which the tension profile is arranged offset in a transverse direction from the center of the outer surface of the holding element. Alternatively, embodiments are possible in which the tension profile is arranged in a transverse direction centrally on the outer surface of the holding element. By varying the arrangement of the tension profile, the point of application for the tensile force that must be applied to enlarge the gap can be varied. It is also conceivable that several tension profiles are arranged on the holding elements.

Embodiments are possible in which the chamber walls each have, at least in sections, a geometry with a curved cross-section, in particular a circular or oval geometry. The curved, in particular circular or oval, geometry favors homogeneous stress distribution in the chamber walls in order to avoid mechanical stress peaks.

In another particularly preferred embodiment, the holding elements and/or the tension profile have at least one cooling element, in particular a cooling element in the form of an extension or rib. This additionally increases the surface area of the heat transfer body and achieves better heat transfer or cooling of the holding device.

It is particularly advantageous if the tension profile comprises a cooling element to improve the cooling properties of the tension profile. In other words, the tension profile combines the function as an assembly aid and the function as a cooling element. For this purpose, the tension profile has, at least in sections, an I-shaped, an E-shaped, an L-shaped and/or a T-shaped geometry in a cross-section. These geometries are particularly advantageous for combining the function of the tension profile as an assembly aid and as a cooling element.

In a preferred embodiment, the holding elements each have an inner surface which bounds the gap, wherein at least one recess extends in the longitudinal direction of the heat transfer body on at least one inner surface. The recess serves as a receptacle for a frame of the heating element.

The frame provides a better hold for the heating element. In particular, this prevents displacement of the heating element in a direction orthogonal to the longitudinal direction of the heat transfer body. The frame is made of plastic, for example, and is arranged around the heating element at least in sections.

It is advantageous if at least one chamber wall has on an outer surface at least one receptacle for a fastening means. The receptacle can be designed, for example, as a guide and/or a hole for a screw. The fastening means may, for example, be a clip fastening, a rail, or a hook. The fastening means and the receptacle preferably form a releasable fastening. In this way, the holding device can be easily arranged in a housing, in particular a control cabinet, and removed or replaced as required.

It is further advantageous if at least one holding element comprises a bore extending in the longitudinal direction of the heat transfer body. In this case, the bore is preferably arranged in the region of the holding element or the tension profile. The bore can save material and reduce the weight of the holding device. Furthermore, the bore can comprise a thread, for example for a grounding screw. The bore additionally causes an increase in the surface area of the holding device. As a result, more heat can be dissipated to the environment.

In a further embodiment, the chamber walls each have, at least in sections, an angular geometry in cross-section, in particular a triangular or polygonal geometry. The angular geometry of the chamber walls can be used, among other things, to influence the rigidity of the chamber walls.

It is further possible for the chamber walls to have both curved and angular geometry in sections. In other words, the curved and angular designs of the chamber walls and the resulting advantages can be combined.

It is particularly advantageous if the holding device has at least one plane of symmetry extending in the longitudinal direction of the holding device. This makes it possible for the holding elements to each be subjected to a uniform force through the chamber walls. Alternatively, it is possible for the holding device to have two planes of symmetry, each extending in the longitudinal direction of the holding device and arranged orthogonally to one another. In other words, the holding device may have two axes of symmetry in cross-section.

In one embodiment, at least one of the chamber walls has outer cooling elements, in particular outer cooling elements formed as extensions or ribs, which are arranged on an outer surface of the chamber wall.

In a further embodiment, at least one of the chamber walls has inner cooling elements, in particular inner cooling elements formed as extensions or ribs, which are arranged on an inner surface of the chamber wall.

The inner and outer cooling elements preferably extend along the entire length of the holding device. The inner and outer cooling elements increase the surface area of the heat transfer body and thus improve its ability to dissipate heat to the environment. Several cooling elements may be arranged on one chamber wall. The cooling elements can have different shapes.

In another embodiment, the chamber walls have sections with different material thickness. Material thickness means the thickness of the material of the chamber wall. In particular, the material thickness is greater in the region that is close to the holding element than in the region that is far from the holding element. This structure favors the stiffness or elastic deformability of the chamber walls and the mechanical stress profile.

To facilitate simple production, the holding elements and the heat transfer body are formed in one piece, in particular monolithically. Furthermore, in this way there are no joining or connecting points at which fractures can occur.

Preferably, the holding device is adapted to have a plurality of sequentially arranged heating elements arranged between the holding elements and each applied with a holding force. This means that several heating elements can be arranged in the gap.

In one embodiment, the holding device has an incision that extends orthogonally to the longitudinal direction of the holding device in order to be able to individually clamp different sequentially arranged heating elements. This means that tolerances are compensated individually for each separate heating element by the individual clamping sections and thus an ideal tension is applied. In other words, manufacturing tolerances of the heating elements can thus be compensated so that all heating elements are subjected to the same holding force. The incision divides the heat transfer body into individual sections or segments so that individual gap widths can be set for each section. The individual sections or segments each form a separate holding region for a single heating element. If several heating elements are arranged in series, an incision is formed between each two heating elements so that heating elements with different tolerances due to production and thus different heights are nevertheless held with the same holding force.

Particularly preferably, the incision is made with a circular saw. Other cutting tools, for example a band saw, are also possible. When using a circular saw, low local stresses are produced, while the clamping force as well as the elastic deformability are maintained. When making the incision with the circular saw, the circular saw is placed centrally on the holding device orthogonally to the longitudinal direction. This produces an arc-shaped incision with a deepest extension in the area of the gap. Towards the outside, the cutting depth decreases.

The holding device can thus comprise, for example, one or more individual holding segments and is preferably made in one piece with the at least four lever arms and/or the corresponding multiples of the holding segments.

For better heat transfer to the environment, the holding device has, at least in sections, a profiling on the outer surface of the heat transfer body. The profiling is preferably in the form of grooves or ribs. Other shapes are possible.

An alternative independent aspect of the invention relates to a heating device having a holding device, and at least one heating element, in particular a PTC heating element or a mica heating element, wherein the heating element is arranged between the holding elements.

Another alternative independent aspect of the invention relates to a method for manufacturing a heating device, in which a holding device is manufactured or provided in accordance with one of the exemplary embodiments described above, wherein the opposite holding elements are moved away from each other in opposite directions by applying an external force so that the width of the gap increases, at least one heating element is arranged in the gap, and subsequently the external force is removed so that the width of the gap decreases and the heating element is applied with a force by the lever arms and held.

### BRIEF DESCRIPTION OF THE DRAWINGS

The invention is explained in more detail below by means of exemplary embodiments with reference to the accompanying drawings.

The drawings show as follows:

FIG. 1 shows a perspective view of an exemplary embodiment of a holding device according to the invention;

FIG. 2 shows a cross-section of the holding device according to FIG. 1;

FIG. 3 shows a perspective view of a further exemplary embodiment of a holding device according to the invention;

FIG. 4 shows a cross-section of the holding device according to FIG. 3;

FIG. 5 shows a perspective view of a further exemplary embodiment of a holding device according to the invention;

FIG. 6 shows a cross-section of the holding device according to FIG. 5;

FIG. 7 shows a perspective view of a further exemplary embodiment of a holding device according to the invention;

FIG. 8 shows a cross-section of the holding device according to FIG. 7;

FIG. 9 shows a perspective view of a further exemplary embodiment of a holding device according to the invention;

FIG. 10 shows a cross-section of the holding device according to FIG. 9;

FIG. 11 shows a perspective view of a further exemplary embodiment of a holding device according to the invention;

FIG. 12 shows a cross-section of the holding device according to FIG. 11;

FIG. 13 shows a cross-section of the holding device according to FIG. 1 with a heating element without frame;

FIG. 14 shows a cross-section of the holding device according to FIG. 1 with a heating element with frame;

FIG. 15 shows a perspective view of a further exemplary embodiment of a holding device according to the invention;

FIG. 16 shows a cross-section of the holding device according to FIG. 15;

FIG. 17 shows a perspective view of a further exemplary embodiment of a holding device according to the invention;

FIG. 18 shows a cross-section of the holding device according to FIG. 17;

FIG. 19 shows a perspective view of a further exemplary embodiment of a holding device according to the invention;

FIG. 20 shows a cross-section of the holding device according to FIG. 19, showing two states;

FIG. 21 shows a perspective view of a further exemplary embodiment of a holding device according to the invention with incision;

FIG. 22 shows a cross-section of a further exemplary embodiment of a holding device according to the invention with incision;

FIG. 23 shows a perspective side view of the holding device according to FIG. 22;

FIG. 24 shows a side view of interconnected PTC heating elements;

FIG. 25 shows a top view of interconnected PTC heating elements according to FIG. 24.

### DESCRIPTION OF AN EMBODIMENT

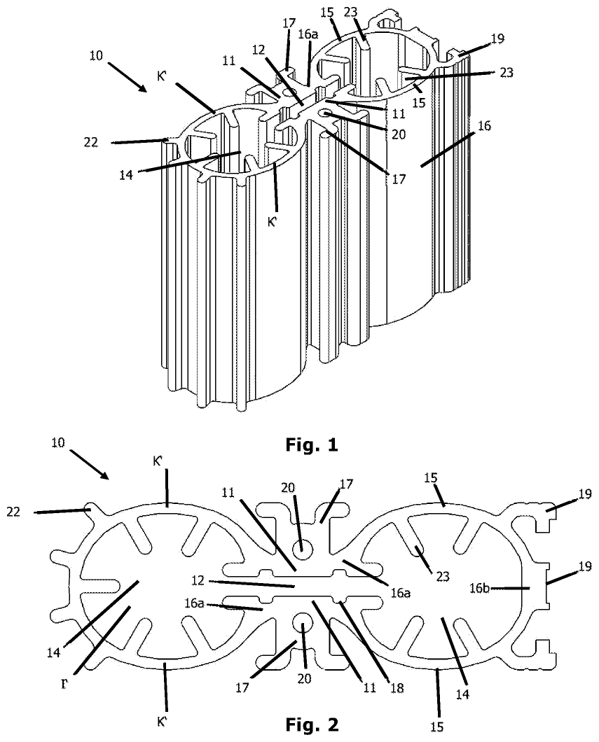

FIG. 1 and FIG. 2 show a holding device 10 with a heat transfer body 16. The heat transfer body 16 comprises two chambers 14 and two holding elements 11.

The chambers 14 have chamber walls K′. In the present exemplary embodiment, the chambers 14 each have two chamber walls K′, which are arranged opposite each other. In each case, one of the chamber walls K′ is connected to a holding element 11 and to another of the chamber walls K′.

The holding elements 11 are arranged opposite and between the chambers 14. The chambers 14 are each open at the axial ends in the longitudinal direction so that a gaseous medium can flow through them.

Accordingly, the longitudinal direction is to be understood as the direction in which a gaseous medium can flow through the chambers 14.

A transverse direction is understood to be a direction that extends orthogonally to the longitudinal direction or the direction of flow.

The holding elements 11 are spaced apart by a gap 12. The gap 12 is bounded by inner surfaces of the holding elements 11. The inner surfaces are adapted to the heating element 13 to be used. The inner surfaces extend parallel to each other, are arranged opposite each other and face each other. If required, the shape of the inner surfaces can be varied. The holding elements 11 each have two recesses 18 on an inner surface. The recesses 18 extend along the entire longitudinal direction of the holding device 10.

The holding elements 11 each have a tension profile 17 on one outer surface. The outer surfaces face away from the gap 12. A bore 20 is arranged in each of the tension profiles 17, which extends along the entire longitudinal direction of the heat transfer body 14. Embodiments without bores are possible. The tension profile 17 has two angled webs. The angled webs are directed away from each other. This means that the angled regions of the webs extend in opposite directions. The webs can also be described as being L-shaped in cross-section. Alternatively, other shapes of the tension profiles 17 are possible.

The shape of the holding device 10 is essentially in the form of a figure eight. The holding device 10 has a plane of symmetry that is orthogonal to the longitudinal direction. More precisely, the plane of symmetry extends parallel to the gap 12.

The chamber walls K′ are curved towards the holding elements 11. The chamber walls K′ each have a convex curvature. The convex curvature of the chamber walls K′ in each case faces in the direction in which the holding element 11, which is connected to the respective chamber wall K′, can be moved to enlarge the gap 12. In other words, the convex curvature of a chamber wall K′ is in each case directed away from an opposite chamber wall K′ which is associated with the same chamber 14.

Preferably, the circular arc chords of the curved chamber walls K′ lie on the same straight line and/or are parallel to each other. Further preferably, the chamber walls K′ have a center angle between 150° and 180°.

The heat transfer bodies 14 are essentially hollow or oval in cross-section. The hollow or oval cross-section of the heat transfer bodies results in the shape of a figure of eight described above. Alternatively and/or additionally, the heat transfer bodies may have polygonal elements at least in sections. The chambers 14 each have an inner region I′. The two inner regions I′ are connected to each other by the gap 12.

The chamber walls K′ have outer and inner cooling elements 22, 23. The cooling elements 22, 23 can also be referred to as surface extensions.

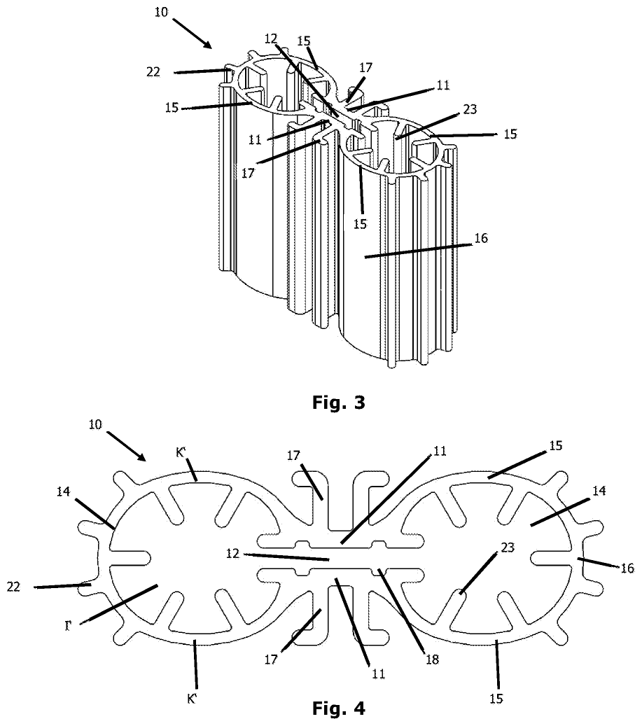

The outer and inner cooling elements 22, 23 are formed as ribs. The outer cooling elements 22 extend radially outward and the inner cooling elements 23 extend radially into the chamber 14. The ribs of the outer and inner cooling elements 22, 33 each extend along the entire longitudinal direction of the heat transfer body 14. Alternatively, other designs or a different number of cooling elements are possible. In an alternative embodiment, it is possible for both chambers 14 to have outer and inner cooling elements 22, 23 (cf. FIGS. 3 to 12).

The chamber 14, which includes inner cooling elements 23, has a receptacle 19 for a fastening means. The receptacle 19 is arranged on an outer surface of the chamber wall K′. The receptacle 19 is arranged on the chamber wall K′ facing away from the holding elements 11 and extends in the longitudinal direction of the holding device 10. The receptacle 19 comprises a guide extending along the entire length in the longitudinal direction. An opening, for example a bore, is arranged between the guide. A hook-shaped clip, for example, can be inserted into the guide and fastened through the bore with a screw. Further designs of the receptacle 19 are conceivable.

The holding element is shaped or designed in such a way that elastic deformation is possible or favored. For this purpose, the chamber walls K′ are adapted in such a way that they form a kind of collet. This maintains the tension even under the influence of heat and does not reduce the heating power or heat flow. This improves the heat transfer function.

More specifically, the chamber walls K′ have a first end and a second end. The first end of a chamber wall K′ is connected to a holding element 11 and the second end is connected to an opposite chamber wall K′. The lever arm corresponds to the distance between the first end and the second end.

The parting line of the chamber walls K′ of the heat transfer body 16 forms a mirror plane. The mirror plane in FIG. 1 extends centrally through the gap 12 and parallel to the inner surfaces of the holding elements 11. In other words, the connecting ends of the opposing chamber walls K′ of the two chambers 14 lie on the mirror plane. Alternatively, the plane forms the parting line between the chamber walls K′ of a chamber passing centrally through the gap 12. In the described exemplary embodiment, this plane corresponds to the mirror plane.

The exemplary embodiment according to FIGS. 3 and 4 is essentially the same as the previously described exemplary embodiment. In contrast to the previously described exemplary embodiment, the exemplary embodiment according to FIGS. 3 and 4 does not have a bore in the tension profile 17. Instead, the two L-shaped webs facing away from each other are spaced apart by a clearance.

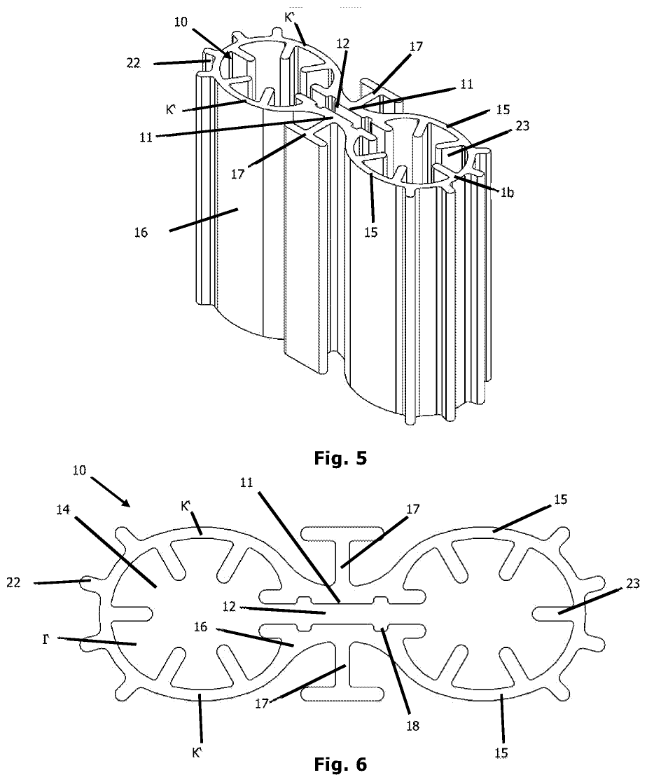

The holding devices 10 shown in FIGS. 3 and 4 and in FIGS. 5 to 12 do not comprise a receptacle 19 for a fastening means. Thus, said holding devices 10 have two planes of symmetry, each extending parallel to the longitudinal direction of the holding device 10 and each orthogonal to the other. In other words, said exemplary embodiments have two symmetry axes in cross-section.

The exemplary embodiment according to FIGS. 5 and 6 also differs from the exemplary embodiment according to FIGS. 3 and 4 by the tension profile 17. The tension profile 17 according to FIGS. 5 and 6 is T-shaped.

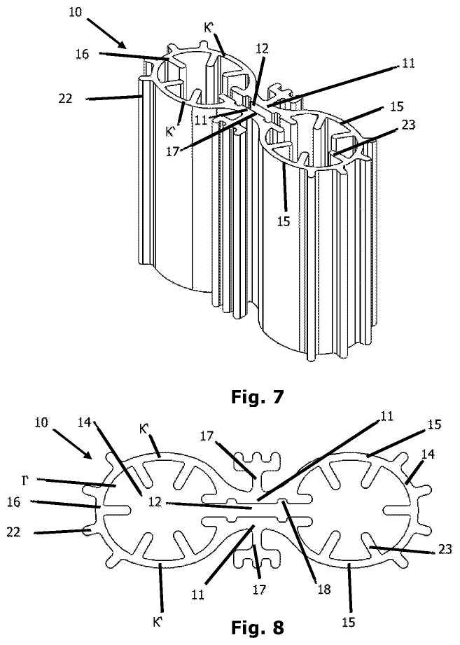

The exemplary embodiment according to FIGS. 7 and 8 differs, like the preceding exemplary embodiments, by the tension profile 17, which here has an E-shaped geometry. More precisely, three further extensions are arranged on a T-shaped geometry. The effect of the extensions is that the tension profile 17 additionally has an improved heat transfer function.

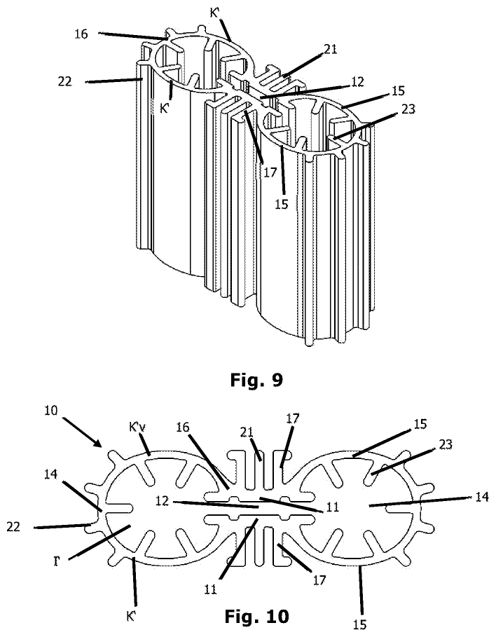

The exemplary embodiment according to FIGS. 9 and 10 corresponds essentially to the exemplary embodiment according to FIGS. 3 and 4. The tension profile 17 according to the exemplary embodiment of FIGS. 9 and 10 has a further rib between the L-shaped webs. The further rib forms an additional cooling element 21.

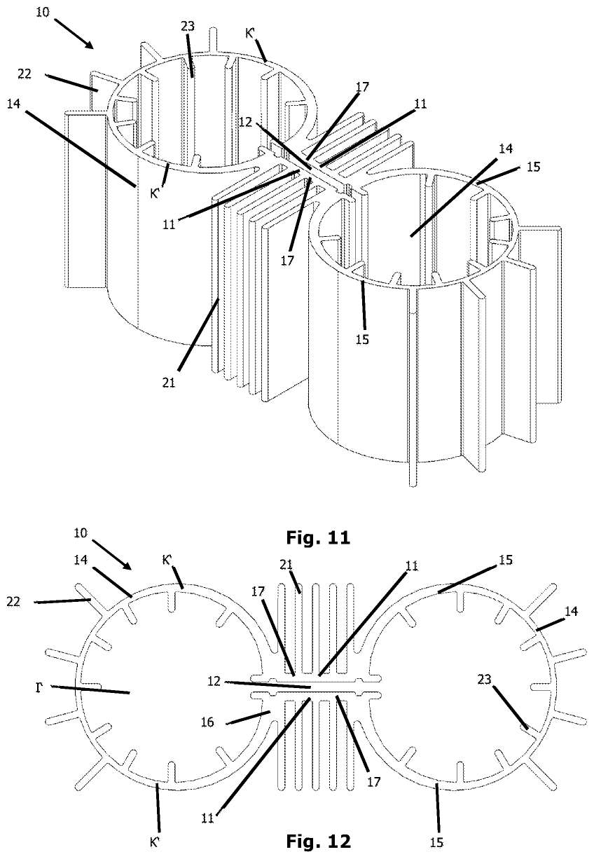

The exemplary embodiment according to FIGS. 11 and 12 has circular heat transfer bodies 14. More precisely, the chamber walls K′ form two circular chambers 14. The thickness or material thickness of the chamber walls K′ is greater in the region of the holding elements 11 than in the region remote from the holding elements 11. Five additional cooling elements 21 arranged parallel to one another are arranged on the outside of the holding elements 11 and extend away from the holding elements 11.

This design improves the stiffness of the chamber walls K′ and is advantageous for the mechanical stress profile in the chamber walls K′.

In the case of a circular heat transfer body 14, the length of the lever arm of the chamber walls K′ essentially corresponds to the diameter of the chambers 14.

In contrast to the previous embodiments, the circular chambers 14 have eleven inner cooling elements 23.

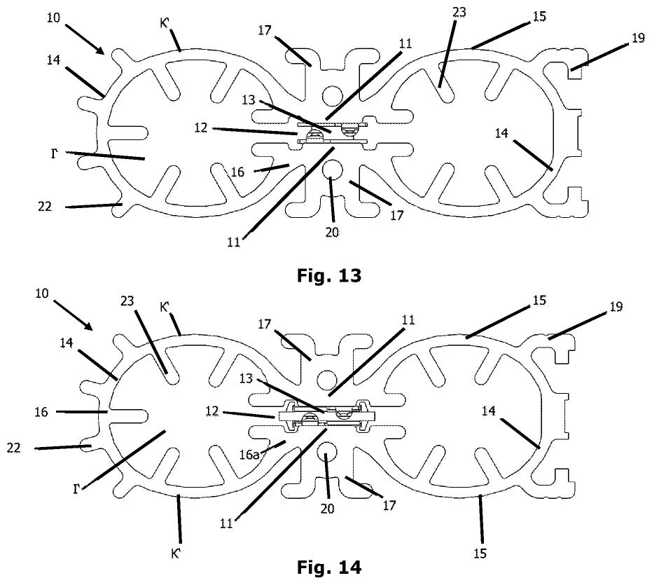

The holding device 10 according to FIGS. 13 and 14 corresponds to the holding device 10 described in FIGS. 1 and 2. In FIGS. 13 and 14, a heating element 13 is arranged in the gap 12 between the holding elements 11 in each case.

The exemplary embodiment according to FIG. 13 differs from the exemplary embodiment according to FIG. 14 in that the heating element 13 in FIG. 13 does not have a frame. In contrast, the heating element 13 in FIG. 14 has a frame. The frame is arranged in the recesses 18 of the holding elements 11.

The frame is part of a support element on which the heating element, for example a PTC heating element, is arranged or pre-mounted. The frame cooperates with the recesses 18. The recesses 18 form a guide in which the heating element 13 is guided in the installed state or can be inserted for assembly. The recess 18 thus enables easy mounting of the heating element 13.

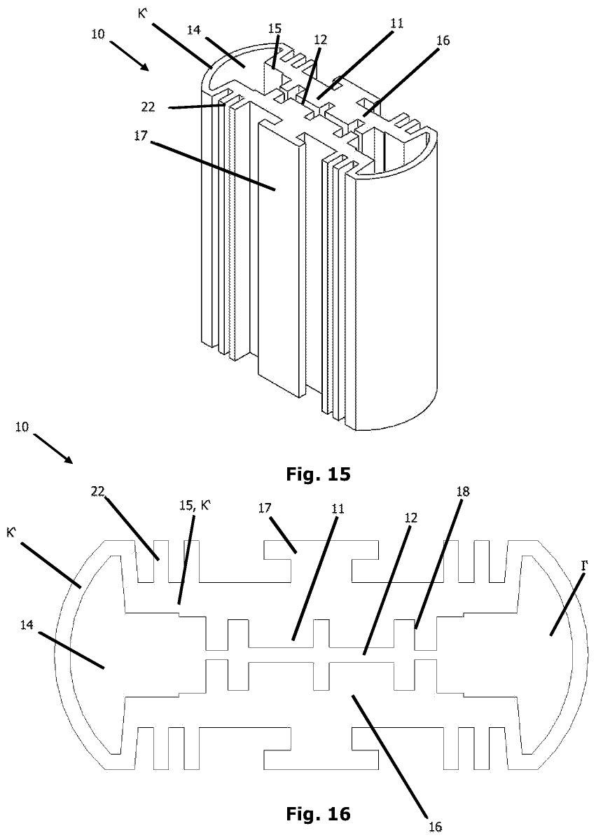

FIG. 15 and FIG. 16 show a further exemplary embodiment. The exemplary embodiment has two axes of symmetry in cross-section. The shape of the chambers 14 is mushroom-shaped. Specifically, the inner contour of the chamber walls K′ of the chambers 14 is mushroom-shaped or umbrella-shaped. The chamber walls K′ each have a curved or circular arcuate section and a polygonal or angular section. The curved section is each convex in a direction away from the gap 12.

The curved section is in each case arranged on the outside in the transverse direction. The polygonal section is arranged between the curved section and the holding element 11 and is connected to these in each case, in particular formed in one piece. The curved section and the polygonal section together form a chamber wall K′. Specifically, the curved section and the polygonal section form a lever arm 15.

The curved section protrudes beyond the holding element 11, which is connected to the corresponding chamber wall K′. The polygonal section tapers in the direction of the holding elements 11. For this purpose, the polygonal section has a step which is inclined in a direction away from the central longitudinal axis. The geometry of the chamber walls increases the rigidity of the heat transfer body 16, allowing strong holding force and good heat transfer.

Two outer cooling elements 22 are arranged on the outer surfaces of each of the chamber walls K′. Thus the heat transfer body 16 has a total of eight outer cooling elements 22. The outer cooling elements 22 are designed as ribs which extend in the longitudinal direction of the heat transfer body 16.

The holding elements 11 each have three recesses 18 on the inner surfaces to hold one or more heating elements 13. The tension profile 17, which is arranged on each of the holding elements 11, has a T-shaped geometry.

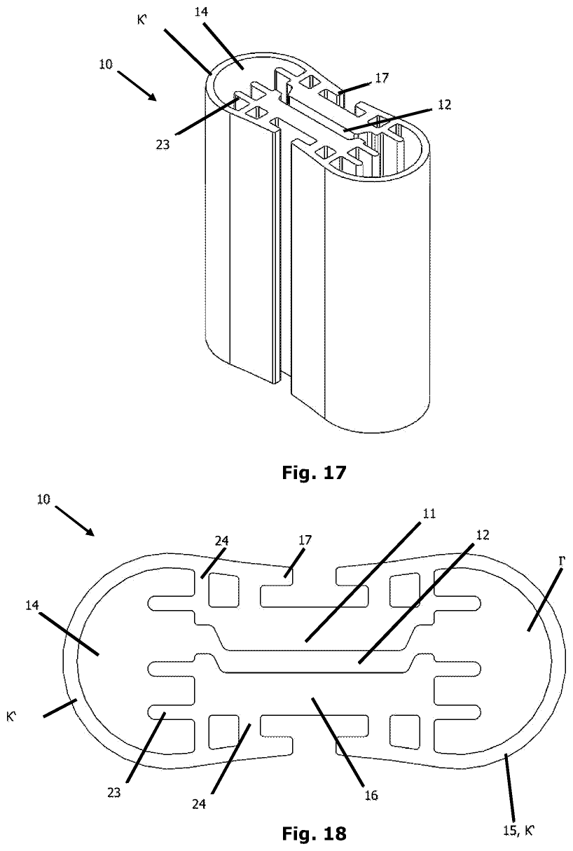

FIGS. 17 and 18 show an exemplary embodiment in which the chambers 14 are essentially semicircular in cross-section. The chamber walls K′ have a correspondingly curved or arcuate geometry in cross-section. The chamber walls K′ are connected to the holding elements 11 by means of connecting webs 25. The chamber walls K′ have open axial ends in cross-section, each of which projects beyond one of the connecting webs 25. The open ends of two opposing chamber walls K′ form the tension profile 17. In other words, in the exemplary embodiment shown here, the chamber walls K′ merge into the tension profile.

The holding elements 11 have a form-fit contour for better retention of the heating element 13 on the inner surfaces, which are designed to be complementary to one another. The form-fit contour is formed by lateral projections on the inside of a holding element 11 and corresponding lateral recesses on the opposite holding element 11, each extending in the longitudinal direction of the heat transfer body.

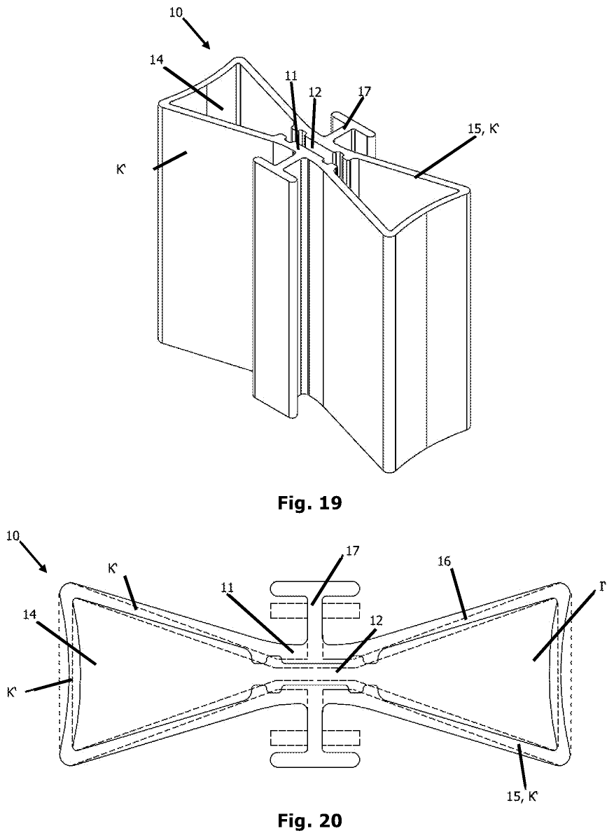

FIGS. 19 and 20 show a heat transfer body 16 with chambers 14 of triangular cross-section. The chamber walls K′ of the heat transfer body 16 form an isosceles triangle in cross-section, with two of the chamber walls K′ of one of the chambers 14 each forming a leg and one of the chamber walls K′ of one of the chambers 14 each forming a base of the triangle. The chamber walls K′ forming the legs are each connected to a holding element 11.

FIG. 20 shows two different states of the holding device 10 according to FIG. 19. The full line shows the state of the holding device 10 when an external tensile force is applied to the tension profile 17 and the gap 12 is increased. This state is referred to as the deformed state. The dashed line shows the state when no external tensile force is applied to the tension profile 17. This state is referred to as the resting state.

In the deformed state of the holding device 10, the chamber walls K′ are elastically deformed and the gap 12 is enlarged compared to the resting state of the holding device 10. This means that the distance between the opposing holding elements 11 is increased. The chamber walls K′, which each form the base of the isosceles triangle, are straight in the rest state. In the deformed state, these chamber walls K′ have a concave curvature in the direction of the holding elements 11.

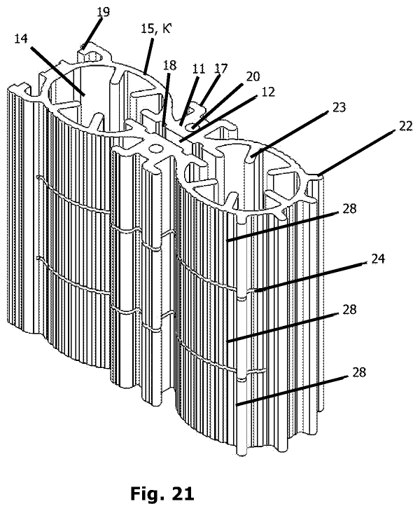

FIG. 21 shows an exemplary embodiment similar to that shown in FIG. 1. The exemplary embodiment shown additionally shows profiling on the outside of the heat transfer body 16. The profiling makes it possible to dissipate more heat to the environment.

The holding devices 10 shown can be adapted by mechanical processing to receive a plurality of heating elements 13. The heating elements 13 are preferably arranged in a row in the longitudinal direction of the heat transfer body 16.

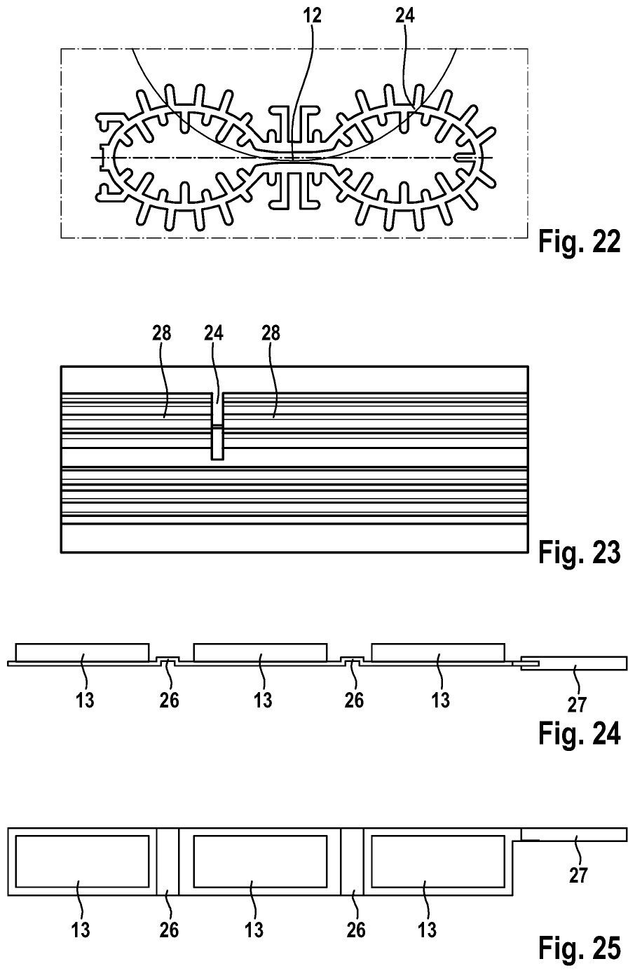

Exemplary embodiments of such machined holding devices 10 are shown in FIG. 21 and in FIGS. 22 and 23.

Two incisions 24, which extend in a transverse direction and are spaced apart from one another in a longitudinal direction, are arranged on the outside of the holding device 10 according to FIG. 21. The incisions 24 extend on only one half of the holding device 10. Specifically, only one holding element 11 has the incisions 24. The incisions 24 define clamping regions 28 that are spaced apart from one another.

FIG. 22 shows how the incision 24 is made by means of a circular saw. It can be seen that the circular saw is placed centrally on the holding element 11. The incision 24 extends to the gap 12. FIG. 23 shows a perspective side view of the incision 24 according to FIG. 22.

The incisions 24 allow the gap 12 to be of different sizes in the longitudinal direction. This allows for a better holding function over the entire holding device 10. Furthermore, this allows different heating elements 13 to be arranged in the gap 12, since the incisions 24 form several clamping regions 28 or segments that are arranged sequentially in the longitudinal direction but are mechanically separated from one another. This makes it possible to apply a coordinated holding force to each heating element 13. Thus, an ideal holding force can be applied to each heating element 13. The separate clamping regions 28 also make it possible to compensate for tolerance differences.

Thus, the holding device 10 can provide any number of clamping regions 28 for any number of heating elements 13, and can be manufactured as a single piece or monolithically.

FIG. 24 and FIG. 25 show a schematic representation of a heating element arrangement with a sequential structure suitable for a holding device 10 with multiple clamping regions 28. The heating element arrangement includes three PTC heating elements 13 arranged in series one behind the other. The individual PTC heating elements 13 are each connected to the adjacent PTC heating element 13 by a sheet metal strip 26. The heating element 13 includes a line 27 to be connected to a power source.

The mode of operation of the holding device described above is explained in more detail below. In the assembled or installed state of the holding device 10, the holding elements 11 hold the heating element 13, which is arranged in the gap 12 between the holding elements 11. In this case, the heating element 13 is in close contact with the inner surfaces of the holding elements 11. Due to the close contact of the heating element 13 with the inner surfaces of the holding elements 11, heat can be transferred to the heat transfer body 16 during operation.

The heat transfer body 16 serves to dissipate heat to the environment so that, for example, constant climatic conditions can be realized in a control cabinet and, in particular, the formation of condensation water is prevented. The outer and inner cooling elements 22, 23, as well as the additional cooling elements 21 increase the surface area of the heat transfer body 14 and further improve this property.

To install the heating element 13, the holding elements 11 are moved away from each other while applying an assembly force, in particular an external tensile force. This increases the width of the gap 12. The heating element 13 is then inserted into the widened gap 12. When the assembly force is applied, the chamber walls K′ are elastically deformed. The assembly force is transmitted to the holding elements 11 by a tool which interacts with the tension profile 17. Alternatively, an assembly force can be applied directly to the holding elements 11. When the assembly force is removed, a restoring force acts on the holding elements 11. The restoring force acting on a holding element 11 is in each case directed in the direction of the opposite holding element 11.

As a result, the heating element 13 is clamped or held between the holding elements 11.

The chamber walls K′ form lever arms which are elastically deformable and exhibit mechanical tension in the elastically deformed state. The tension causes the holding or restoring force with which the heating element 13 is held between the two holding elements 11.

The tension profile 17 is designed to interact with a tool. In particular, tension profiles comprising a T- or L-shaped geometry have engagement surfaces in which the tool can engage and apply an external tensile force so that the holding elements 11 can be moved away from each other to enlarge the gap 12 and arrange a heating element 13 in the gap 12. It is possible for a plurality of heating elements 13 to be arranged between the holding elements 11. The heating elements 13 may, for example, be arranged next to each other, wherein the heating elements 13 are preferably not in contact with each other.

The features of the described exemplary embodiments are not limited to the individual embodiments, but can be freely combined with each other.

### LIST OF REFERENCE SIGNS

I′ Interior
K′ Chamber wall
10 Holding device
11 Holding element
12 Gap
13 Heating element
14 Chamber
15 Lever arm
16 Heat transfer body
17 Tension profile
18 Recess
19 Receptacle
20 Bore
21 Cooling element
22 Outer cooling elements
23 Inner cooling elements
24 Incision
25 Connecting webs
26 Sheet metal strip
27 Line
28 Clamping region

1-20. (canceled)

21. A holding device for at least one heating element, the holding device comprising
at least two oppositely arranged holding elements which are spaced apart from one another by a gap, which extends along a longitudinal direction of the holding device and is adapted to receive the at least one heating element, and
a heat transfer body having at least two chambers, which each form an inner region through which a gaseous medium can flow, wherein the holding elements are arranged between the chambers and the gap connects the inner region of the chambers, wherein at least one tension profile is arranged on at least one outer surface of the holding elements, to which profile a tensile force can be applied in order to increase a size of the gap for receiving the at least one heating element, wherein the chambers have chamber walls, which form lever arms at least in sections, wherein the lever arms can be elastically deformed at least in sections by the tensile force and are connected to the holding elements in such a way that, in the installed state, a holding force is applied to the at least one heating element.

22. The holding device according to claim 21, wherein the chamber walls of the chambers each have substantially a same shape, in particular the chamber walls form the lever arms of equal length, and the holding elements are arranged centrally between the chambers in a transverse direction.

23. The holding device according to claim 21, wherein the chamber walls of the chambers have different shapes from one another, in particular the chamber walls form the lever arms of different lengths from one another, so that the holding elements are arranged offset in a transverse direction from a center between the chambers.

24. The holding device according to claim 21, wherein the chamber walls each have, at least in sections, a geometry with a curved cross-section, in particular a circular or oval geometry.

25. The holding device according to claim 21, wherein the holding elements and/or the at least one tension profile have at least one cooling element, in particular in the form of an extension or a rib.

26. The holding device according to claim 25, wherein the at least one tension profile and/or the at least one cooling element have, at least in sections, an I-shaped, an E-shaped, an L-shaped and/or a T-shaped geometry in a cross-section.

27. The holding device according to claim 21, wherein the holding elements each have an inner surface which bounds the gap, wherein at least one recess extends in the longitudinal direction of the heat transfer body on at least one inner surface.

28. The holding device according to claim 21, wherein at least one of the chamber walls has on an outer surface at least one receptacle for a fastening means.

29. The holding device according to claim 21, wherein at least one of the holding elements and/or the at least one tension profile further comprises a bore extending in the longitudinal direction of the heat transfer body.

30. The holding device according to claim 21, wherein the chamber walls each have, at least in sections, an angular geometry in cross-section, in particular a triangular or polygonal geometry.

31. The holding device according to claim 21, wherein the holding device has at least one plane of symmetry extending in the longitudinal direction of the holding device.

32. The holding device according to claim 21, wherein at least one of the chamber walls has outer cooling elements, in particular formed as extensions or ribs, which are arranged on an outer surface of the at least one of the chamber walls.

33. The holding device according to claim 21, wherein at least one of the chamber walls has inner cooling elements, in particular formed as extensions or ribs, which are arranged on an inner surface of the at least one of the chamber walls.

34. The holding device according to claim 21, wherein the chamber walls have sections with different material thickness.

35. The holding device according to claim 21, wherein the holding elements and the heat transfer body are formed in one piece, in particular monolithically.

36. The holding device according to claim 21, wherein the holding device is adapted to have a plurality of sequentially arranged heating elements arranged between the holding elements and each applied with a holding force.

37. The holding device according to claim 36, wherein the holding device has an incision that extends orthogonally to the longitudinal direction of the holding device in order to be able to individually clamp different ones of the sequentially arranged heating elements.

38. The holding device according to claim 21, wherein the holding device has, at least in sections, a profiling on an outer surface of the heat transfer body.

39. A heating device having the holding device according to claim 21 and at least one of the heating elements, in particular a PTC heating element or a mica heating element, wherein the at least one of the heating elements is arranged between the holding elements.

40. A method for manufacturing a heating device, in which the holding device according to claim 21 is provided, wherein the holding elements are moved away from each other in opposite directions by applying an external force, so that a width of the gap increases, at least one of the heating elements is arranged in the gap, and subsequently the external force is removed so that the width of the gap decreases and the at least one of the heating elements is applied with a force by the lever arms and held.
